(19) United States
(12) Patent Application Publication
(10) Pub. No.: US 2005/0219380 A1
(43) Pub. Date: Oct. 6, 2005

(54) Digital camera for determining chromaticity coordinates and related color temperature of an object and method thereof

(75) Inventor: Mu-Hsing Wu, Chiayi City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/086,609

(22) Filed: Mar. 22, 2005

(30) Foreign Application Priority Data
Mar. 31, 2004 (TW) 93108930

(51) Int. Cl. H04N 9/73; H04N 5/228

(52) U.S. Cl. 348/223.1; 348/222.1

(57) ABSTRACT

A digital camera for determining the chromaticity coordinates and the related color temperature of an object and the method thereof. A photosensor receives the reflected light of the object and outputting image data. An averaging unit outputs the red average, the green average and the blue average according to the image data. A chromaticity coordinate unit transforms the red average, the green average and the blue average into tristimulus values using a transformation matrix and outputs a chromaticity coordinate according to the tristimulus values. A color temperature unit outputs the color temperature according to the chromaticity coordinates.

This application claims the benefit of Taiwan application Serial No. 093108930, filed Mar. 31, 2004, the subject matter of which is incorporated herein by reference.

### BACKGROUND OF THE INVENTION

1. Field of the Invention

The invention relates in general to digital cameras, and more particularly to digital cameras for determining the chromaticity coordinates and the related color temperature of an object.

2. Description of the Related Art

When different observers look at the same object, their perception of colors can vary while under the influence of the surrounding light source and the color of the object itself. Because of these variations, scientific standards have been developed to provide a standard for describing colors and the related issues. According to the trichromatic theory, a color stimulus as observed by an observer can be formed by a combination of three primary colors. Thus, any color stimulus can be expressed in terms of the intensity of the three colors. FIG. 1 illustrates a color matching function determined by the international commission on illumination (CIE). The color matching function is used, under CIE standard observer system established in 1931, to represent the formation of the three primary colors X, Y and Z under different wavelengths, where X, Y, Z are also referred to as the tristimulus values. The chromaticity coordinates x, y, and z are then calculated respectively using the following formulae:
x=X/(X+Y+Z), (1-1)
y=Y/(X+Y+Z), (1-2)
z=Z/(X+Y+Z), (1-3)
wherein the sum of the three chromaticity coordinates x+y+z=1. The value z can be found if x and y are known; thus, the chromaticity coordinate systems usually only involve x and y coordinate axes. Conventionally, a colorimeter is used to provide direct measurements of the tristimulus values X, Y, and Z by using three broad-band filters. The chromaticity coordinates x, y, and z are then found using the corresponding formulae (1-1)-(1-3) for x, y, and z above.

During the research and development of digital cameras, instruments such as colorimeters and correlated color temperature meters are required to measure the relevant color information, such as the chromaticity coordinates of an object and the related color temperature of light reflected off the object, in order to incorporate functions such as automatic white balance (AWB) and color correction into the camera. However, due to the high prices of colorimeters and correlated color temperature meters, it is not economically feasible to provide each research engineer with a colorimeter and a correlated color temperature meter.

### SUMMARY OF THE INVENTION

It is therefore an object of the invention to provide a digital camera for determining the chromaticity coordinates and the related color temperature of an object, and a method thereof, such that the aforementioned problems are solved.

The invention achieves the above-identified object by providing a method of utilizing a digital camera to determine a set of chromaticity coordinates and a related color temperature of an object. The first step includes utilizing the digital camera to capture an image of the object and to output image data. Then, the following step is to respectively calculate a red average, a green average and a blue average according to the red, green and blue primary colors of image data. Next, the red, green and blue averages are transformed into tristimulus values. Then, the next step includes determining the chromaticity coordinates of the object according to the tristimulus values. Then, the related color temperature of the object is determined according to the chromaticity coordinates.

In addition, the invention achieves the other above-identified object by providing a digital camera for determining a set of chromaticity coordinates and a related color temperature of an object. First, photosensor receives light reflected off the object and outputs image data. Then, an averaging unit calculates a red average, a green average and a blue average from the red, green and blue primary colors of the image data. Then, a transformation matrix transforms the three color averages separately into tristimulus values, and outputs the chromaticity coordinates. Then, a color temperature unit outputs the related color temperature of the object according to the chromaticity coordinates.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a graph showing a CIE color matching function.

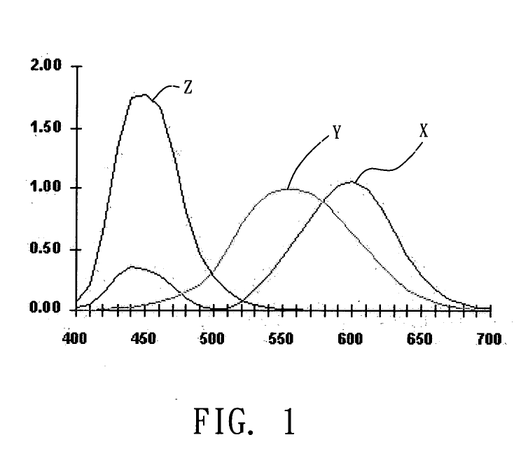

FIG. 2 is block diagram showing a digital camera for determining the chromaticity coordinates and the related color temperature of an object according to a preferred embodiment of the invention.

FIG. 3 shows a flow chart illustrating the utilization of a digital camera to determine the chromaticity coordinates and the related color temperature of an object.

FIG. 4 shows spectral sensitivity distribution curves for respective red, green and blue primary colors of a digital camera according to a preferred embodiment of the invention.

FIG. 5 is CIE chromaticity diagram with a black body radiation curve.3

### DETAILED DESCRIPTION OF THE INVENTION

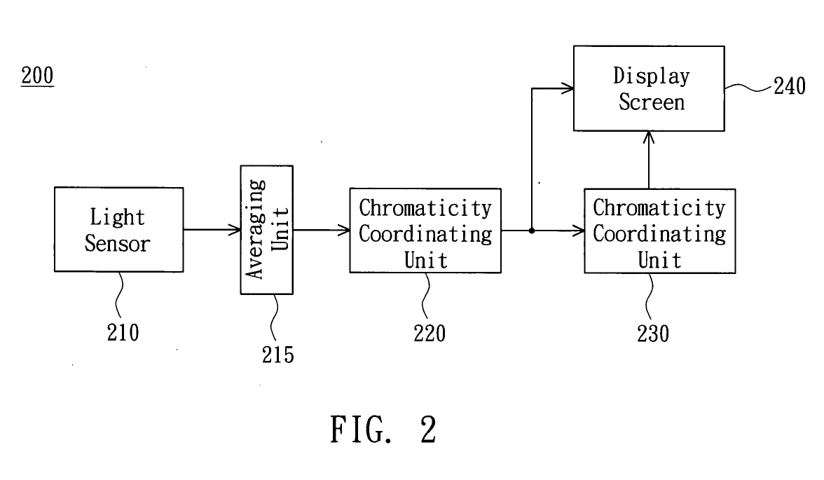

FIG. 2 shows a block diagram of a digital camera for determining the chromaticity coordinates and the related color temperature of an object according to a preferred embodiment of the invention. The digital camera 200 includes a photosensor 210, an averaging unit 215, a chromaticity coordinate unit 220, a color temperature unit 230, and a display screen 240. Photosensor 210, such as charge coupled device (CCD), includes a plurality of pixel sensors, each including 3 primary sensors. The primary sensors are such as red, green and blue sensors, for receiving light reflected off an object and outputting image data. Averaging unit 210 receives image data, and calculates a red average, a green average and a blue average according to the red, green and blue primary colors of image data, respectively. Chromaticity coordinate unit 220 utilizes a transformation matrix to transform the red average, the green average and the blue average separately into the corresponding tristimulus values, and then utilizes the tristimulus values to output the set of chromaticity coordinates to be displayed on display screen 240. The transformation matrix is generated by a transformation matrix generator, which includes a spectral distribution sensor, a sampling unit, and a calculation unit. The spectral distribution is used to obtain a plurality of samples of a spectral sensitivity distribution curve for the digital camera so as to generate a spectral distribution matrix. The sampling unit obtains a plurality of samples of a CIE color matching function so as to generate a stimulus matrix. The calculation unit is for calculating the transformation matrix according to the spectral distribution matrix and the stimulus matrix.

Then, color temperature unit 230 calculates the related color temperature according to the chromaticity coordinates, and outputs the color temperature to be displayed on display screen 240.

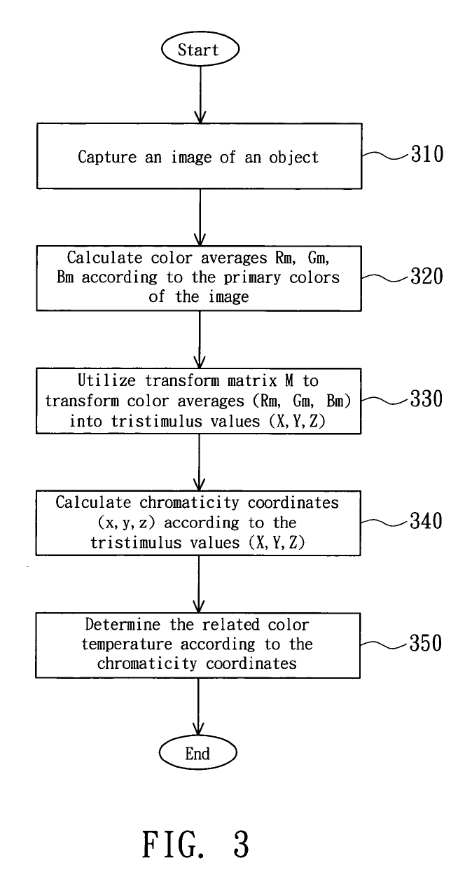

FIG. 3 shows a flow chart illustrating the utilization of a digital camera 200 to calculate the chromaticity coordinates and the related color temperature of an object. The first step involves utilizing the digital camera 200 to capture an image of the object, and causing photosensor 210 of the digital camera 200 to output data image, as indicated in step 310. Next, averaging unit 215 calculates color averages (Rm, Gm, Bm) according to the red, green and blue primary colors of image data, respectively, as shown in step 320. Next, chromaticity coordinate unit 220 utilizes transformation matrix M to transform color averages (Rm, Gm, Bm) into tristimulus values (X,Y,Z), as shown in step 330, and transforms the tristimulus values (X,Y,Z) into chromaticity coordinates (x,y,z) as shown in step 340 by using the above mentioned formulae (1-1), (1-2) and (1-3). Lastly, color temperature unit 230 determines the related color temperature of the object according to the chromaticity coordinates (x,y,z), as shown in step 350.

Matrix M used in step 350 is to transform color averages (Rm, Gm, Bm) of image data into tristimulus values (X,Y,Z), as shown in below formula (2):

$$[ \begin{matrix}X \\ Y \\ Z\end{matrix} ] = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}Rm \\ Gm \\ Bm\end{matrix} ] \qquad ( 2 )$$

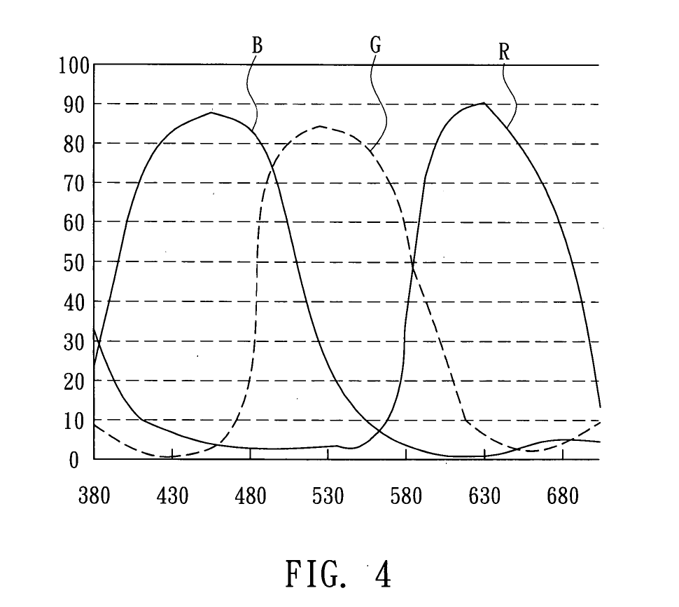

Matrix M is pre-determined according to spectral sensitivity distribution of the digital camera and CIE color matching function. The properties of photosensors vary from camera to camera, where one of the properties of photosensors refer to their spectral sensitivity distribution, which is an indicator for the sensitivity and responsiveness of the digital camera under light with different frequencies. FIG. 4 shows spectral sensitivity distribution curves of a digital camera for use in the embodiment. The spectral sensitivity distribution curves shows the intensity of light detected by the red, green and blue sensors of the digital camera over a range of light frequencies. For example, the spectral sensitivity distribution curves of a digital camera can be determined by successively emitting single-frequency lights over a frequency range to the photosensors of the digital camera and obtaining the intensity of corresponding electrical signals. With respect to human visual perception, spectral sensitivity distribution curves can thus be determined by performing the above described method over the human visual perceptual range from 400 to 700 nm. In addition, signal-frequency light can be generated using turnable monochromators.

After the determination of the spectral sensitivity distribution curves, a transformation matrix M can be obtained according to a stimulus matrix C and a spectral distribution matrix S. For example, by sampling each of the curves for the primary colors at a rate of 10 nm, a total of 31 samples with respect to a primary color are obtained. Hence, a 3×31 spectral distribution matrix S is obtained for the three primary colors:

$$S = [ \begin{matrix}R \\ G \\ B\end{matrix} ]$$

Similarly, a 3×31 stimulus matrix C is determined by sampling the CIE color matching function, and C is as the following:

$$C = [ \begin{matrix}X \\ Y \\ Z\end{matrix} ]$$

Stimulus matrix C is the dot product of spectral distribution matrix S and transformation matrix M (C=S·M). A 31×31 transformation matrix M can thus be calculated mathematically according to a spectral distribution matrix S determined experimentally from the digital camera, and a stimulus matrix C determined from above method. For example, the transformation matrix M can be determined by using the least squares regression method to minimize ∥SM−C∥_{F} such that M=(S^{T}S)¹S^{T}C is desired.

In step 340, after formulae (1-1), (1-2) and (1-3) are applied to transform tristimulus values (X,Y,Z) into chromaticity coordinates (x,y,z), the set of values (x,y,Y) can be displayed on camera display screen, and the color temperature can be calculated in step 350 according to (x,y).

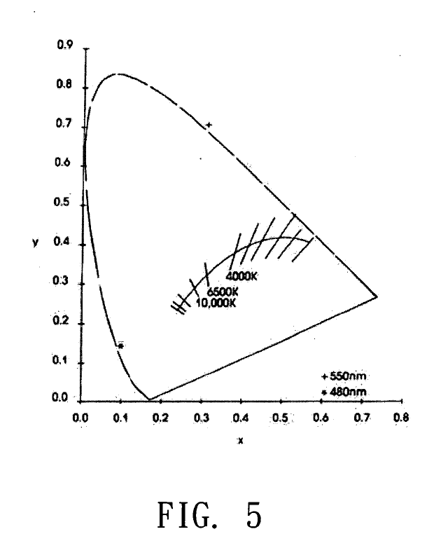

In step 350, the related color temperature of the object is determined according to a blackbody radiation curve. FIG. 5 is the CIE chromaticity diagram with a blackbody radiation curve, where every point on the black radiation curve represents a color and the color temperature of the color is also indicated on the curve. A point on the blackbody radiation curve which is closest to the chromaticity coordinates (x,y) obtained in step 340 is to be determined. The corresponding color temperature of this point is then taken as the related color temperature of the object, and displayed on the display screen of the digital camera.

The embodiments of the invention above discloses the digital camera for determining chromaticity coordinates and related color temperature of an object and the method thereof, in which the digital camera can be manufactured with low costs. Thus, as compared to the conventional use of expensive colorimeters and correlated color temperature meters, using the digital camera under the invention can result in economic efficiency.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of utilizing a digital camera to obtain a set of chromaticity coordinates and a related color temperature of an object, the method comprising:
utilizing the digital camera to capture an image of the object;
calculating a red average, a green average and a blue average of the image according to the red, green and blue primary colors of the image, respectively;
utilizing a transformation matrix to transform the red, green and blue averages into tristimulus values;
determining the chromaticity coordinates of the object according to the tristimulus values; and
determining the related color temperature of the object according to the chromaticity coordinates.

2. The method according to claim 1, wherein the transformation matrix is determined according a plurality of steps, the steps comprising:
determining a plurality of spectral sensitivity distribution curves of the digital camera;
generating a spectral distribution matrix based on a plurality of samples obtained by sampling the spectral sensitivity distribution curves;
obtaining a plurality of samples of a CIE color matching function to generate a stimulus matrix; and
calculating the transformation matrix according to the spectral distribution matrix and the stimulus matrix.

3. The method according to claim 2, wherein the digital camera comprises a plurality of pixel sensors, each of the pixel sensors comprising a plurality of primary color sensors, the step of determining the spectral sensitivity distribution curves comprising:
generating a single-frequency light;
receiving the single-frequency light to output separately a plurality of sensor values by the primary color sensors of the digital camera; and
generating the spectral sensitivity distribution curves according to the sensor values and the frequency of the single-frequency light.

4. The method according to claim 2, wherein the transformation matrix is calculated according to the spectral distribution matrix and the stimulus matrix using a least squares regression method.

5. The method according to claim 1, wherein the related color temperature of the object is determined based on a point of a blackbody radiation curve which is closest to the chromaticity coordinates.

6. A digital camera for determining a set of chromaticity coordinates and a related color temperature of an object, comprising:
a photosensor for capturing an image of the object;
an averaging unit for calculating a red average, a green average and a blue average of the image according to the red, green and blue primary colors of the image, respectively;
a chromaticity coordinate unit, utilizing a transformation matrix to transform the red average, the green average and the blue average into corresponding tristimulus values, and producing a set of chromaticity coordinates according to the tristimulus values; and
a color temperature unit for producing the related color temperature according to the set of chromaticity coordinates.

7. The digital camera according to claim 6, wherein the transformation matrix is generated by a transformation matrix generator, the transformation matrix generator comprising:
a spectral distribution sensor to obtain a plurality of samples of a plurality of spectral sensitivity distribution curves for the digital camera so as to generate a spectral distribution matrix;
a sampling unit to obtain a plurality of samples of a CIE color matching function so as to generate a stimulus matrix; and
a calculation unit for calculating the transformation matrix according to the spectral distribution matrix and the stimulus matrix.

8. The digital camera according to claim 7, wherein the digital camera comprises a plurality of pixel sensors, each of the pixel sensors comprises a plurality of primary color sensors, the spectral distribution sensor uses a monochromator to generate and send the digital camera a single-frequency light, through which the primary sensors of the digital camera based on for outputting a plurality of sensor values, and to generate the spectral distribution curve according to the sensor values and the single-frequency light.

9. The digital camera according to claim 5, wherein the calculation unit of the transformation matrix generator is to calculate the transformation matrix according to the spectral distribution matrix and the stimulus matrix, using the a least squares regression method.

10. The digital camera according to claim 1, wherein the related color temperature of the object is determined based on a related color temperature point on a blackbody radiation curve that is closest to the chromaticity coordinates.
